(19) United States
(12) Patent Application Publication
(10) Pub. No.: US 2008/0179793 A1
(43) Pub. Date: Jul. 31, 2008

(54) Ejector-Plate Actuator of a Molding System

(75) Inventors: Robert Dietrich SCHAD, North York (CA); Martin Richard KESTLE, Everett (CA); Joaquim Martins NOGUEIRA, Everett (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: HUSKY INJECTION MOLDING SYSTEMS LTD., Bolton (CA)

(21) Appl. No.: 11/627,413

(22) Filed: Jan. 26, 2007

(51) Int. Cl. B29C 43/50

(52) U.S. Cl. 264/334; 425/139

(57) ABSTRACT

Disclosed are: (i) an actuator of a molding system, (ii) a molding system including an actuator, (iii) a molded article made by usage of an actuator of a molding system, and (iv) a method of an actuator of a molding system.

### TECHNICAL FIELD

The present invention generally relates to, but is not limited to, molding systems, and more specifically the present invention relates to, but is not limited to, (i) an ejector-plate actuator of a molding system, (ii) a molding system including an ejector plate actuator, (iii) a molded article made by usage of an ejector-plate actuator of a molding system, and (iv) a method of an ejector-plate actuator of a molding system.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems; (www.husky.ca).

U.S. Pat. No. 5,122,051 (Inventor: Joyner; Published: 1992 Jun. 16) discloses an injection molding machine with an article-ejection apparatus where linear and rotary ejection means can be used individually, or in sequence. More specifically, this patent appears to disclose a part ejection apparatus for ejecting molded parts from a mold carried by a moveable platen in an injection molding machine. A plurality of linearly operating hydraulic cylinders are provided to move an ejector bar that is carried along guide rods supported by a moveable platen so that the ejector bar moves toward and away from a mold member that is carried by the moveable platen. Suitable connections can be provided between the ejector bar and the ejection mechanism of the mold to drive ejector pins carried by the mold for separating the molded part from the mold surface. Additionally, a rotary motor is also carried by the moveable platen and has its axis coincident with the longitudinal axis of the moveable platen for connection of an output shaft of the motor with a drive mechanism carried by a mold. The drive mechanism is suitable for rotating rotatable cores that form internal threads on the molded article. The linear and rotary ejection apparatus can be used individually, or they can be used in appropriate sequence in a core-type mold where separation of the cores does not simultaneously effect separation of the part from the mold.

Japanese Patent Application Number 4-168018 (Inventor: Watanabe et al; Published: 16 Jun. 1992) discloses an ejection mechanism in an ejector device for an injection molding machine. More specifically, this patent application appears to disclose an ejector device with an attachment frame fixed to the rear surface of the moving platen in an injection molding machine. A servo motor and a speed reducer are connected to the fixed attachment frame on which a slide plate with an ejector pin projects from its front surface so as to permit movement to the front and rear. The output shaft of the speed reducer and the slide plate are connected by a crank mechanism in which the first link is longer than the second link. One end of the first link is attached firmly to the output shaft of the speed reducer. One end of the second link is attached to the rear surface of the slide plate so as to be freely rotatable. The other ends of the first link and the second link are rotatably joined together. A control means is provided which controls the rotation of the servo motor so that the first link moves reciprocally over a prescribed angular range, which is less than 45 degrees with respect to the line of the injection axis.

U.S. Pat. No. 5,736,079 (Inventor: Kamiguchi et al; Published: 1998 Apr. 7) discloses controlling an ejector for an injection molding machine in which an ejector mechanism is driven by a servo motor. More specifically, this patent appears to disclose an ejector mechanism that is driven by a servo motor. An ejector pin in the ejector mechanism is made to perform a motion such that the ejector pin reaches a predetermined protrusion limit position beyond a position where the removal of a molded product from a cavity or core is completed after making a check for positioning. A plurality of cycles of reciprocating motion of short amplitude is performed such that the ejector pin: (i) neither retracts beyond a position where the removal of the molded product from the cavity or core is started, (ii) nor protrudes to the protrusion limit position without requiring a check for positioning.

U.S. Pat. No. 5,824,350 (Inventor: Wietrzynski; Published: 1998 Oct. 20) discloses a plastic molding tool with an accessory and an ejector or core pin unit that includes a date marking unit at a pin end that faces the plastic material during a molding operation. The date marking unit is used for marking the date of manufacture on components. More specifically, this patent appears to disclose a mold for molding or injection-molding polymer compounds. At least one mold ancillary unit, in particular an ejector device, preferably an ejector pin, and/or a core pin device is distinguished by the fact that the mold ancillary device has, at least over a region, a marker unit in the region facing the polymer compound during the molding or injection-molding of the article.

U.S. Pat. No. 6,165,405 (Inventor: Harmsen et al: Published: 2000 Dec. 26) discloses an apparatus for encapsulation of electronic components mounted on lead frames by using an eccentric drive for mold closing and/or in which one mold half is displaceable against a resisting force. More specifically, this patent appears to disclose a device for encapsulating electronic components mounted on lead frames in a mold assembled from two mold halves that are: (i) moveable relative to each other, and (ii) closable relative to each other. The device, for causing the mold halves to move and to close, is formed by a rotatable eccentric drive, which can be coupled to one of the mold halves with at least one connecting rod. Also described is a method for driving such a connecting rod. Also described is an encapsulating device wherein: (i) a first mold half is connectable to the device for causing the mold halves to move and close, and (ii) a second mold half is connectable to a counter-plate which forms part of the device. The counter-plate is displaceable between two end positions. Also disclosed is an encapsulating device with a counter-plate that includes a plurality of stacked, substantially plate-like parts, between which parts at least one shaft is placed. Also disclosed is a device for exerting pressure on encapsulating material including at least two screw spindles.

PCT Patent Application Number WO 02/40246 (Inventor: Weinmann et al: Published: 23 May 2002) discloses ejection of injection molded components from a molding tool that utilizes a load stored in a spring at the end of an ejection cycle to assist with molding release in the following cycle. More specifically, this patent application appears to disclose a method and an ejection device for the ejection of injection-molded pieces from injection molds. The ejection device includes an electric motor drive for the ejector pin. The electric motor drive, at least in the last section of the return travel thereof, tensions a spring for energy storage. The spring tension force is subsequently used to begin the ejection movement by supporting the breaking free of the injection molded pieces. By means of a particularly advantageous embodiment, the spring force is applied in combination with a cam drive to augment the cam drive maximum in the region of the dead point with the equivalent maximum of the tensile spring force. A slide plate on which ejector pins are mounted is displaced by means of an electric motor using a lever drive. Two particular features are: (i) a support frame open at the rear for the cam movement, and (ii) preferably four guide columns on which the slide plate runs. The slide plate movement is thus more stable and, above all, takes account of the usually unequal releasing force for the various ejector pins.

U.S. Pat. No. 6,811,391 (Inventor: Klaus et al; Published: 2004 Nov. 2) discloses an electrically operated ejector mechanism for ejecting molded parts from a mold. The ejector mechanism uses an electric, reversible servo motor with an output shaft connected to a cam. More specifically, this patent appears to disclose a molded part ejection system that includes a drive mechanism having a reversible servo motor. The drive mechanism for the ejection system includes a cam-and-follower arrangement whereby a circular cam member is driven by the servo motor through a drive shaft that is: (i) connected with the cam member and (ii) offset from the center of the circular cam track. A cam follower is connected with an ejector drive rod. The cam follower rides in the cam track to cause linear movement of the ejector drive rod as the cam follower follows the circular cam through its non-circular path of motion. Rotation of the servo motor in one direction of rotation operates the part ejection system, while rotation of the servo motor in the opposite direction of rotation provides power to another portion of the machine during another portion of a molding machine operating cycle, such as a core-pull system. The servo motor drive shaft includes a pair of one-way clutches that are each operable in a different direction of rotation of the motor drive shaft. In one direction of rotation, the motor actuates a part ejection mechanism. In the other direction of rotation, the motor can provide power to operate a different system of the molding machine. A single motor is permitted to perform two functions at different times during the operating cycle of an injection molding machine.

German Patent Number 10,060,128 (Inventor: Becker et al: Published: 2005 May 12) discloses an ejection mechanism for injection molded components. The mechanism has an ejector plate moved by a crank drive between active and non-active positions. The mechanism includes a spring compressed at the end of the return stroke. More specifically, this patent appears to disclose a device for ejecting injection molded parts from an injection mold held by a platen in an injection molding machine. The device includes an ejection plate to which at least one ejector pin is fixed or can be fixed. The pin is positioned in a moveable tool half of the injection mold in an axially displaceable manner. The ejector-receiving element can be moved from a retraction position into an ejection position via linear guiding mechanisms, parallel to the longitudinal axis of the at least one ejector pin, by means of a motor-driven crank mechanism that includes a crankshaft, a crank and a connecting rod. A spring force storage device is provided in which the spring force thereof acts in the direction of the ejection position. The connecting rod is embodied as an arched component.

### SUMMARY

According to a first aspect of the present invention, there is provided an actuator of a molding system, the actuator including: (i) an ejector plate configured to support an ejector rod, and (ii) connecting links coupled to the ejector plate, the connecting links configured to transmit substantially balanced applied forces to the ejector plate.

According to a second aspect of the present invention, there is provided an actuator of a molding system, the actuator including: (i) an ejector plate, (ii) an ejector rod fixedly connected to the ejector plate, (iii) connecting links pivotally coupled to the ejector plate, the connecting links configured to transmit substantially balanced applied forces to the ejector plate, (iv) cranks pivotally connected to a respective link of the connecting links, (v) crank shafts fixedly connected to respective cranks, (vi) a drive shaft, (vii) an electric motor configured to rotate the drive shaft, and (viii) a belt coupling the drive shaft to the crank shafts, in response to the drive shaft being rotated by the electric motor, the belt moves so as to rotate the crank shafts, in response to the crank shafts being rotated by the belt, the cranks rotate so as to move the connecting links, in response to the connecting links being pushed by the cranks, the ejector plate receives the substantially balanced applied forces from the connecting links, in response to the ejector plate receiving the substantially balanced applied forces, the ejector rod move through a moveable platen of the molding system and a moveable mold portion supported by the moveable platen, the ejector rods pushes a molded article molded and retained in the moveable mold portion, transmission of the substantially balanced applied forces includes: (a) transmission of a net orthogonal translational force to the ejector plate so as to translate the ejector plate, the net orthogonal translational force being aligned orthogonal relative to the ejector plate, and (b) transmission of a net non-orthogonal force to the ejector plate that is substantially reduced as the net orthogonal translational force is transmitted to the ejector plate, the net non-orthogonal force being aligned non-orthogonal relative to the ejector plate.

According to a third aspect of the present invention, there is provided a molding system, having an actuator including: (i) an ejector plate configured to support an ejector rod, and (ii) connecting links coupled to the ejector plate, the connecting links configured to transmit substantially balanced applied forces to the ejector plate.

According to a fourth aspect of the present invention, there is provided a molding system, having: (a) a stationary platen configured to support a stationary mold portion of a mold, (b) a moveable platen being moveable relative to the stationary platen, the moveable platen configured to support a moveable mold portion of the mold, (c) an extruder configured to process and to inject a molding material into a cavity defined by the mold, and (d) an actuator including: (i) an ejector plate being moveable relative to the moveable platen, (ii) an ejector rod fixedly connected to the ejector plate, the ejector rod being moveable through the moveable platen and the moveable mold portion so as to abut a molded article to be molded and retained in the moveable mold portion, (iii) a guidance assembly configured to supportively guide movement of the ejector plate, and (iv) connecting links pivotally coupled to the ejector plate, the connecting links configured to apply substantially balanced applied forces to the ejector plate, (v) cranks pivotally connected to a respective link of the connecting links, (vi) crank shafts fixedly connected to respective cranks, (vii) a drive shaft, (viii) an electric motor configured to rotate the drive shaft, and (ix) a belt coupling the drive shaft to the crank shafts, in response to the drive shaft being rotated by the electric motor, the belt moves so as to rotate the crank shafts, in response to the crank shafts being rotated by the belt, the cranks rotate so as to move the connecting links, in response to the connecting links being pushed by the cranks, the ejector plate receives the substantially balanced applied forces from the connecting links, in response to the ejector plate receiving the substantially balanced applied forces, the ejector rod move through a moveable platen of the molding system and a moveable mold portion supported by the moveable platen, the ejector rod pushes a molded article molded and retained in the moveable mold portion, transmission of the substantially balanced applied forces includes: (a) transmission of a net orthogonal translational force to the ejector plate so as to translate the ejector plate, the net orthogonal translational force being aligned orthogonal relative to the ejector plate, and (b) transmission of a net non-orthogonal force to the ejector plate that is substantially reduced as the net orthogonal translational force is transmitted to the ejector plate, the net non-orthogonal force being aligned non-orthogonal relative to the ejector plate.

According to a fifth aspect of the present invention, there is provided a molded article made by usage of an actuator of a molding system, the actuator including: (i) an ejector plate configured to support an ejector rod, and (ii) connecting links coupled to the ejector plate, the connecting links configured to transmit substantially balanced applied forces to the ejector plate.

According to a sixth aspect of the present invention, there is provided a molded article made by usage of a molding system, having an actuator including: (i) an ejector plate configured to support an ejector rod, and (ii) connecting links coupled to the ejector plate, the connecting links configured to transmit substantially balanced applied forces to the ejector plate.

According to a seventh aspect of the present invention, there is provided a method of an actuator of a molding system, including transmitting substantially balanced applied forces to an ejector plate, the ejector plate configured to support an ejector rod.

A technical effect, amongst other technical effects, of the aspects of the present invention is, amongst other things, reduction of wear of components associated with the ejector plate and/or equalizing releasing force associated with ejector rods.

### DETAILED DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

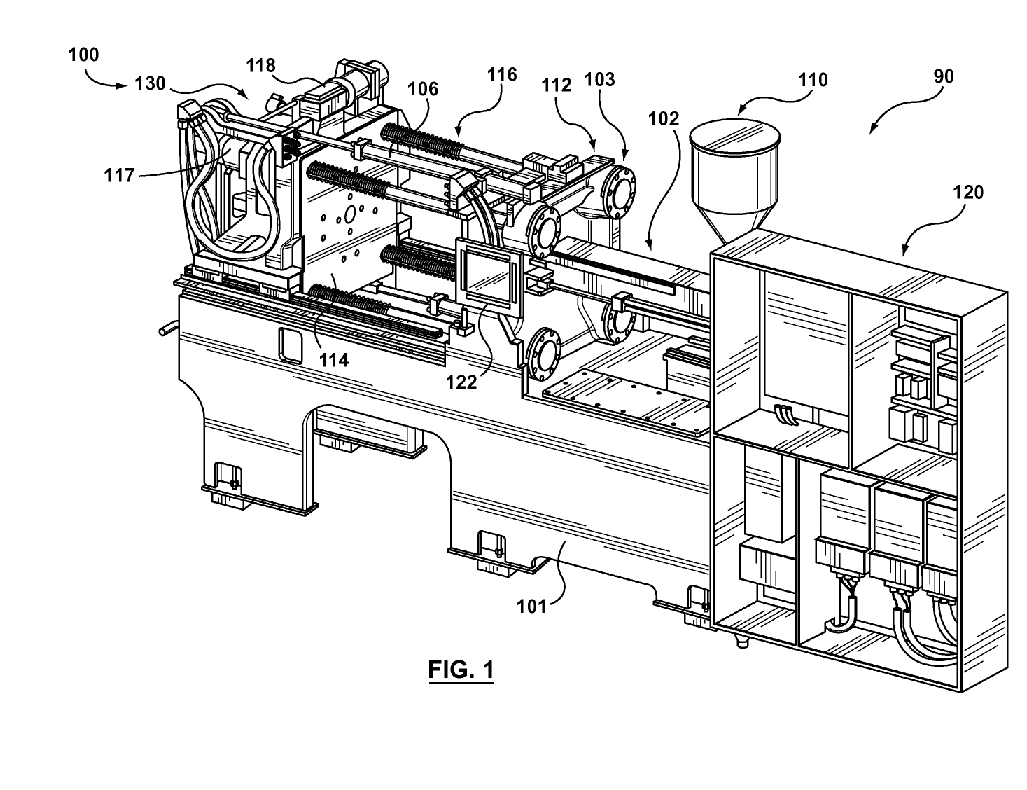

FIG. 1 is a perspective view of a molding system according to a first exemplary embodiment;

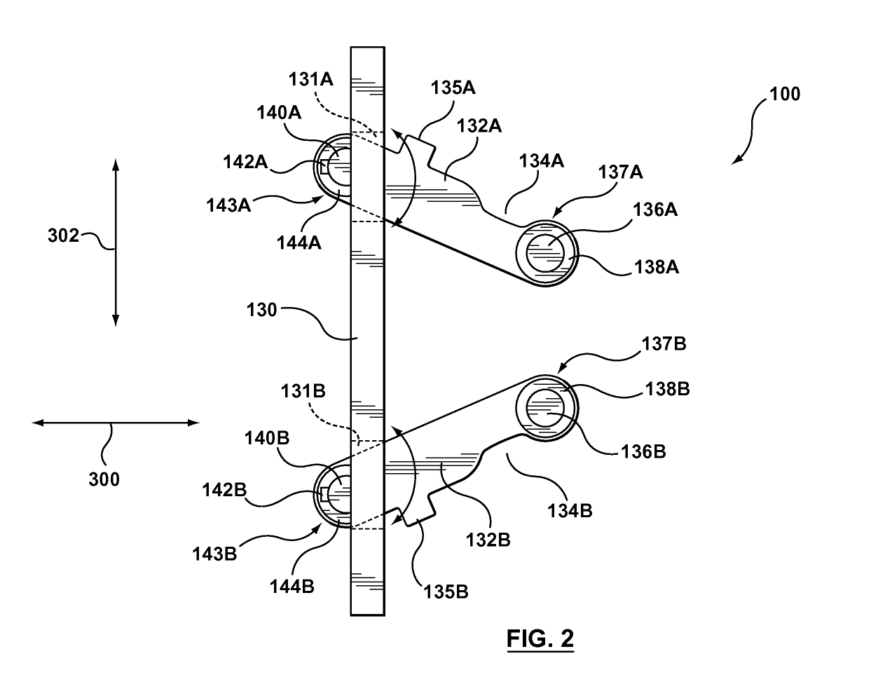

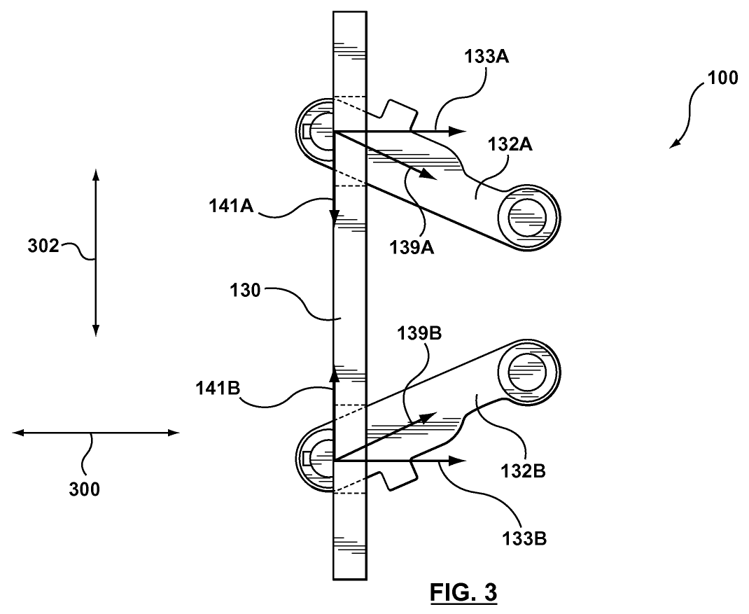

FIGS. 2 and 3 are side views of an actuator of the molding system of FIG. 1 according to the first exemplary embodiment;

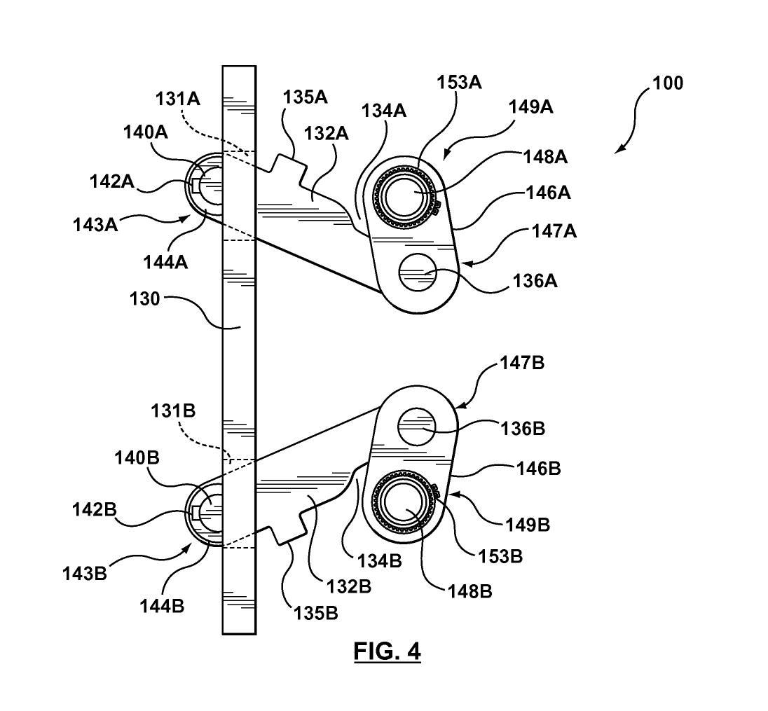

FIG. 4 is a side view of an actuator of the molding system of FIG. 1 according to a second exemplary embodiment;

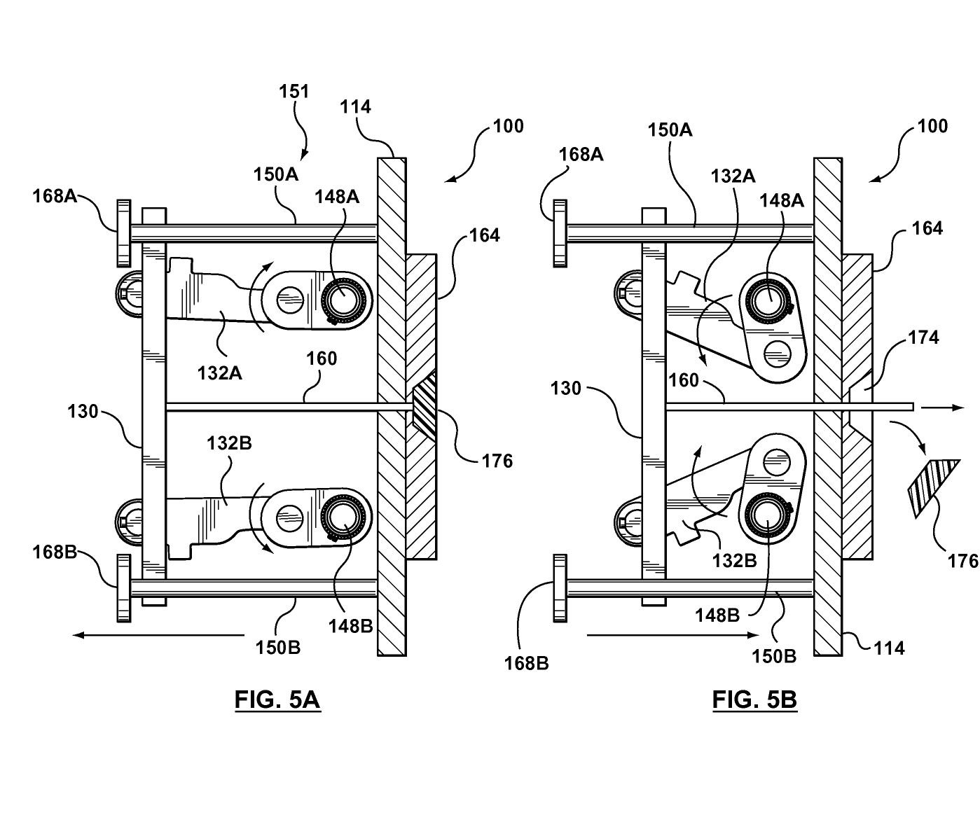

FIGS. 5A and 5B are side views of an actuator of the molding system of FIG. 1 according to a third exemplary embodiment;

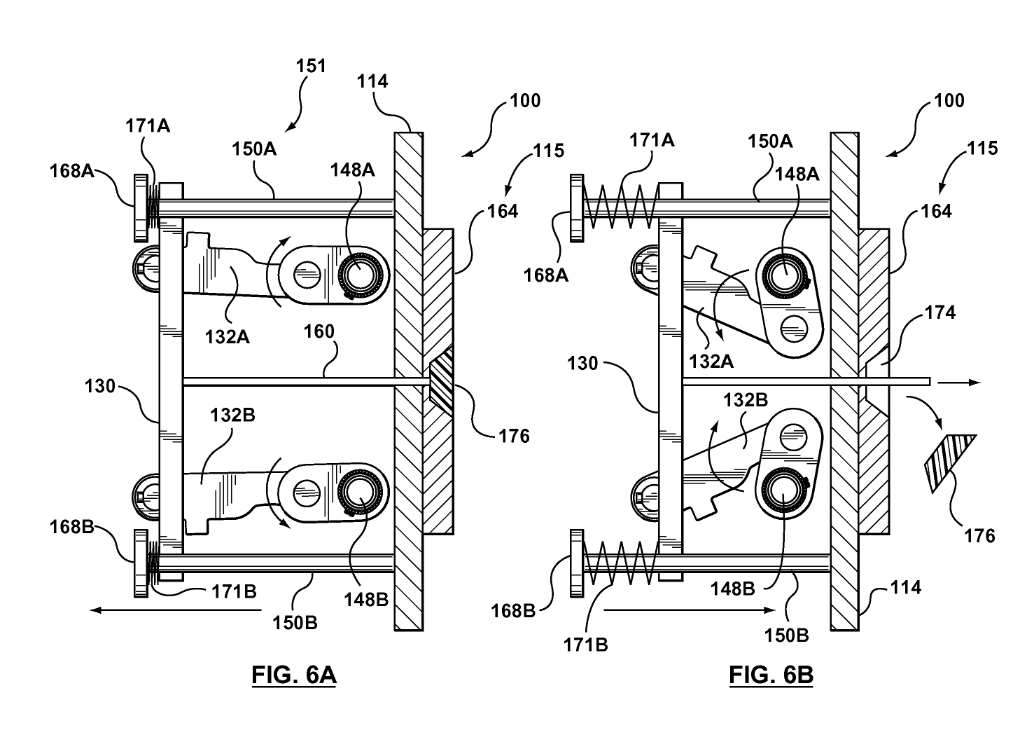

FIGS. 6A and 6B are side views of an actuator of the molding system of FIG. 1 according to a fourth exemplary embodiment;

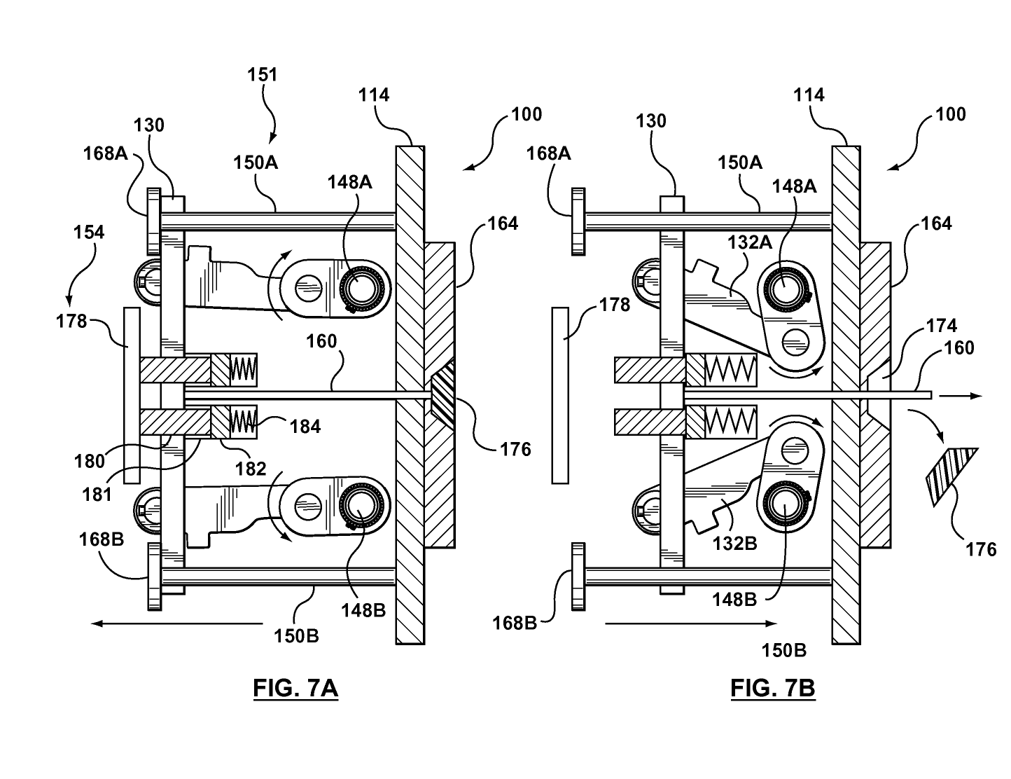

FIGS. 7A and 7B are side views of an actuator of a molding system of FIG. 1 according to a fifth exemplary embodiment (which is the preferred embodiment or best mode);

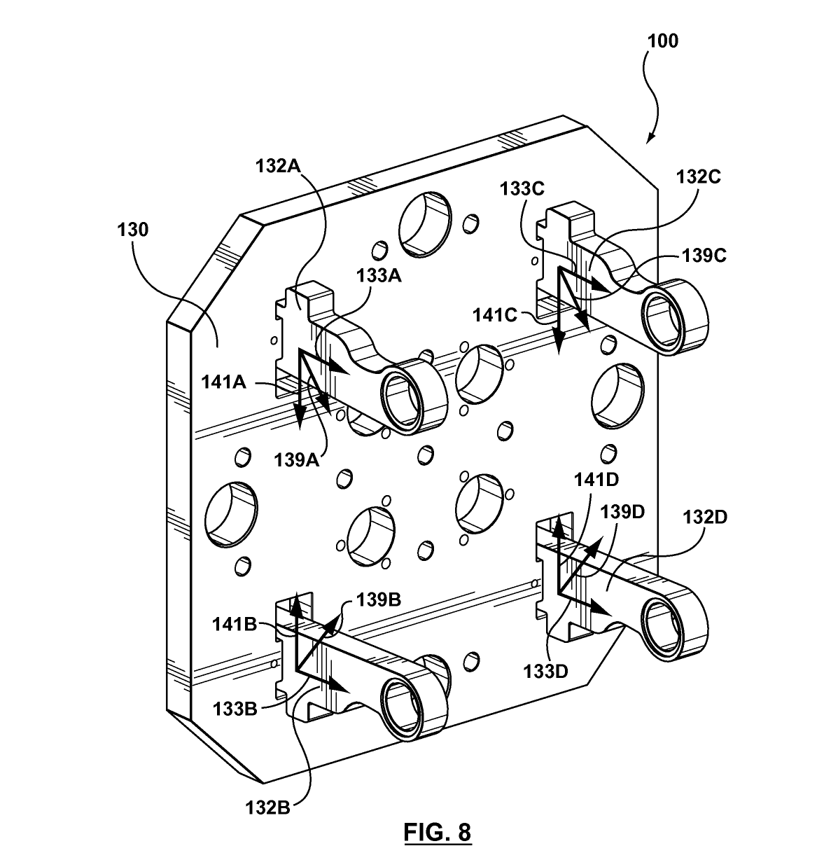

FIG. 8 is a perspective view of the actuator of the molding system of FIG. 1 according to the first exemplary embodiment;

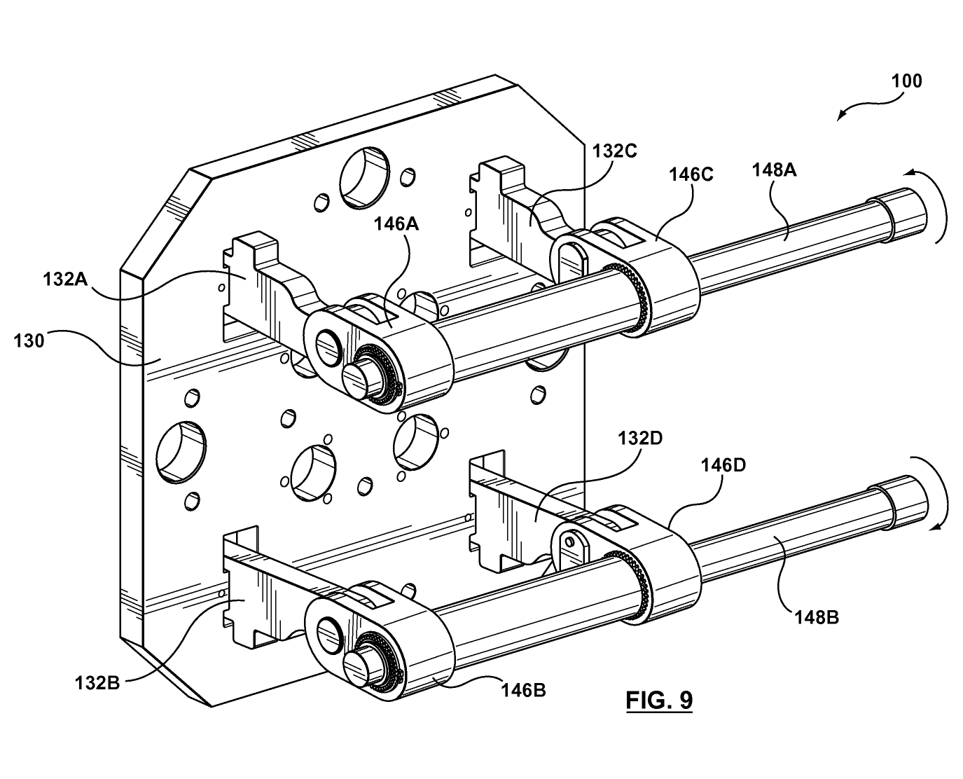

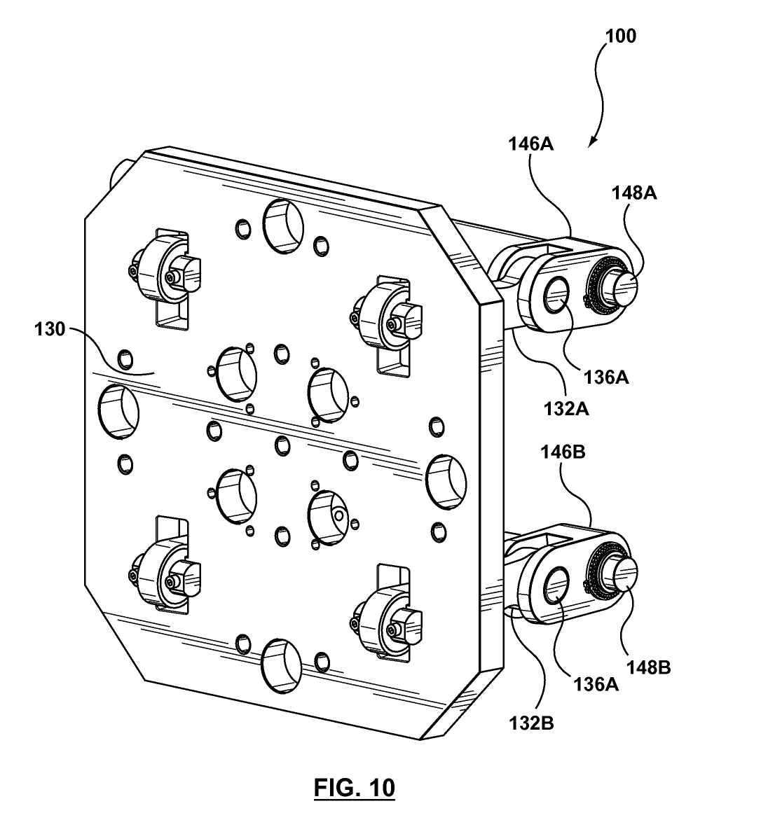

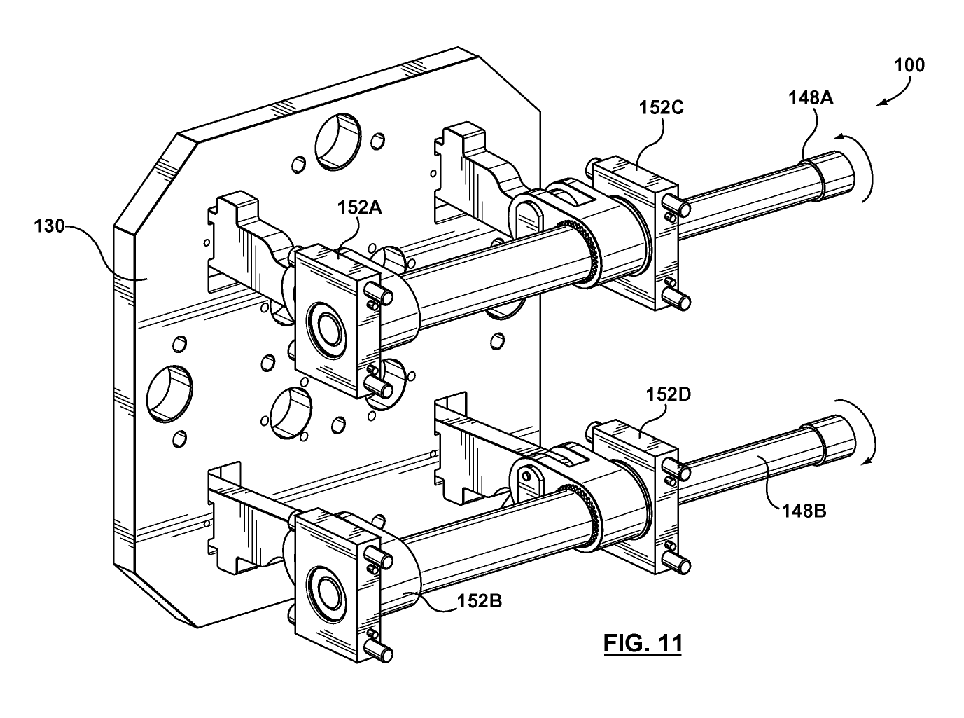

FIGS. 9, 10 and 11 are perspective views of the actuator of the molding system of FIG. 1 according to the third exemplary embodiment;

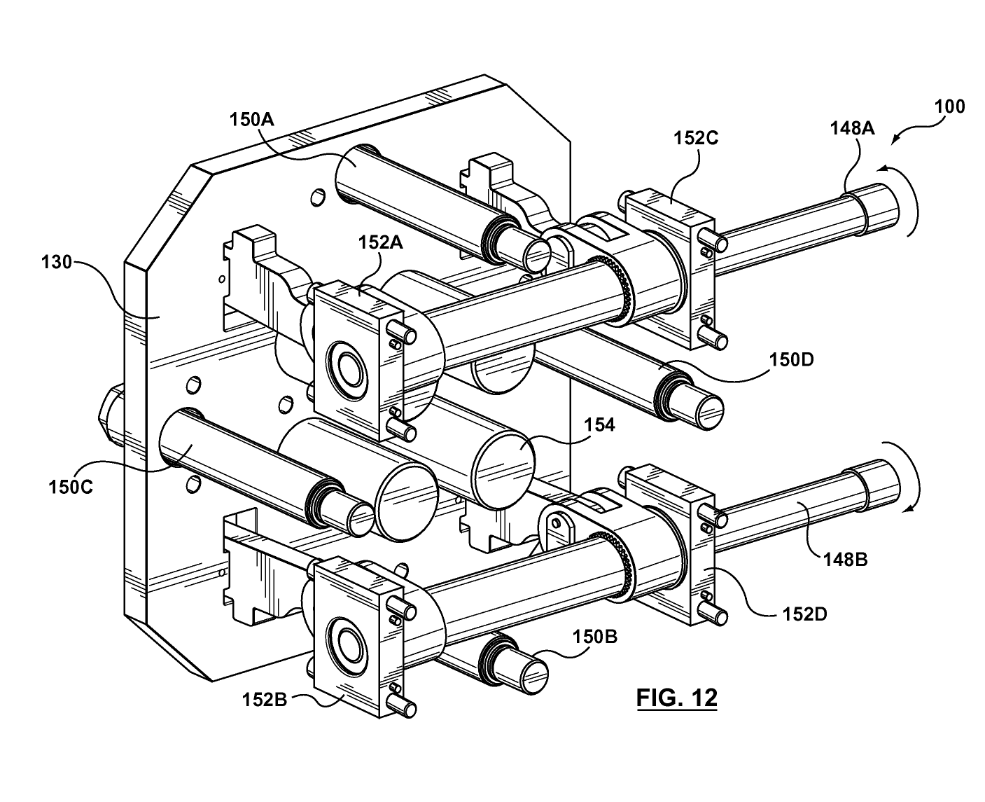

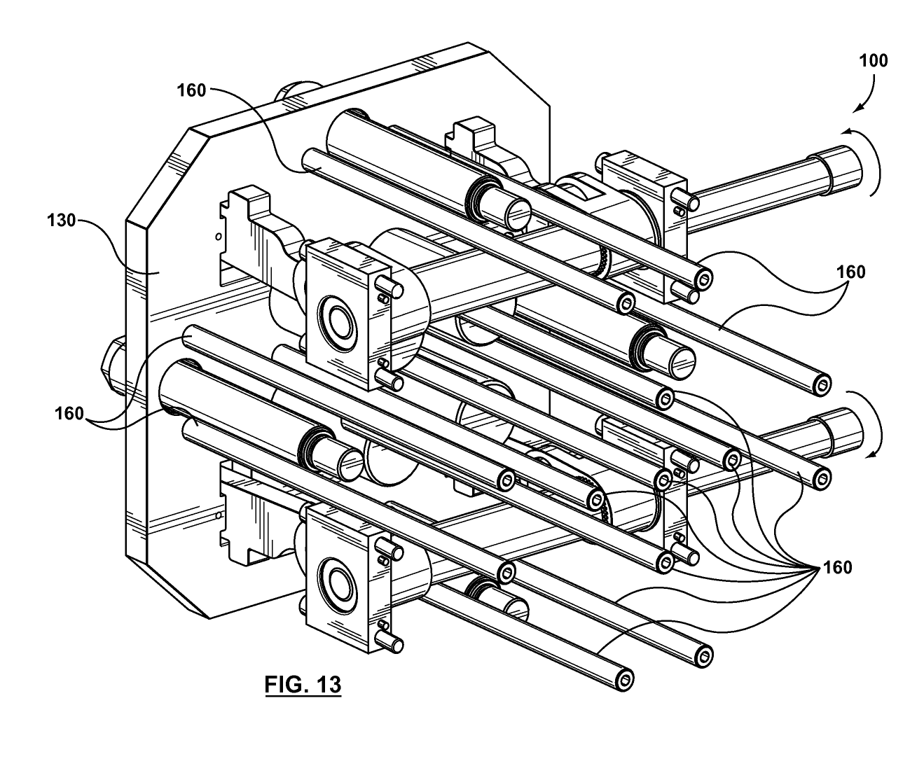

FIGS. 12 and 13 are perspective views of the actuator of the molding system of FIG. 1 according to the fifth exemplary embodiment; and

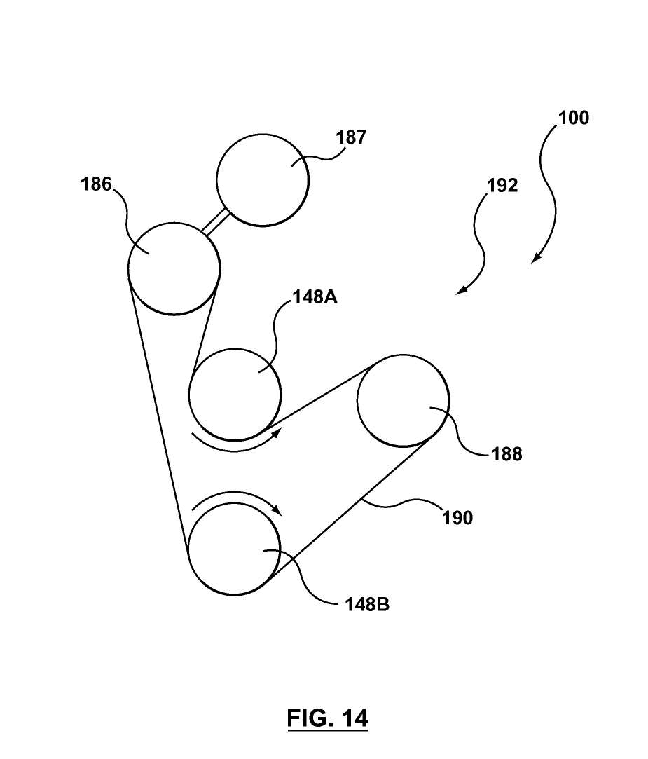

FIG. 14 is a side view of the actuator of the molding system of FIG. 1 according to a sixth exemplary embodiment.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

FIG. 1 is the perspective view of a molding system 90 (preferably an injection molding system hereafter referred to as the “system 90”) according to the first exemplary embodiment. The system 90 is used to mold a molded article 176 (which is depicted at least in part in FIG. 5A). The system 90 includes components that are known to persons skilled in the art and these known components will not be described here; these known components are described, by way of example, in the following references: (i) Injection Molding Handbook by Osswald/Turng/Gramann ISBN: 3-446-21669-2; publisher: Hanser, and (ii) Injection Molding Handbook by Rosato and Rosato ISBN: 0-412-99381-3; publisher: Chapman & Hill. The system 90 includes (amongst other things): (i) an injection-type extruder 102 (hereafter referred to as the “extruder 102”), (ii) a hopper 110, (iii) a control cabinet 120, (iv) a human-machine interface 122 (hereafter referred to as the “HMI 122”), (v) a stationary platen 112, (vi) a moveable platen 114, and (vii) an actuator 100 (which is depicted at least in part in FIGS. 2 and 3). FIG. 1 depicts an approximate location of the actuator 100 relative to the system 90. The extruder 102 has a barrel and a reciprocating screw disposed in the barrel. Alternatively, the extruder 102 could be a two stage shooting pot configuration. The hopper 110 is coupled to a feed throat of the extruder 102 so as to deliver pellets of moldable material to the extruder 102. The extruder 102 is configured to: (i) process the pellets into an injectable molding material, and (ii) inject the injectable material into a mold that is held closed by the platens 112, 114 after the platens 112, 114 have been stroked together. The control cabinet 120 houses control equipment that is used to control the system 90. The HMI 122 is coupled to the control equipment, and the HMI 122 is used to assist an operator in monitoring and controlling operations of the system 90. The stationary platen 112 is configured to support a stationary mold portion of a mold (not depicted in FIG. 1). The moveable platen 114 is configured to: (i) support a moveable mold portion of the mold (depicted at least in part in FIG. 5A), and (ii) move relative to the stationary platen 112 so that the mold portions of the mold may be separated from each other or closed together. A platen stroke actuator 106 (hereafter referred to as the “actuator 106”) is coupled to the platens 112, 114. Preferably, there are two platen stroke actuators, each of which are mounted, respectively, at opposite diagonal corners of the platens 112, 114. The actuator 106 is used to stroke the moveable platen 114 relative to the stationary platen 112. The stationary platen 112 supports four clamp actuators 103 that are each positioned in respective corners of the stationary platen 112. Four tie bars 116 each extend from their respective clamp actuators 103 toward respective corners of the moveable platen 114. The tie bars 116 are lockable relative to the moveable platen 114 by usage of respective tie-bar locks 117 that are each supported in respective corners of the moveable platen 114. An ejector plate 130 (depicted at least in part in FIG. 2) is located on the back side of the moveable platen 114. FIG. 1 depicts an approximate location of the ejector plate 130 relative to the system 90. The actuator 100 is used to move, displace or linearly translate the ejector plate 130. The ejector plate 130 is fixedly connected to a set of ejector rods (that is, one or more ejector rods) that are depicted at least in part in FIGS. 5A and 5B.

FIGS. 2 and 3 are the side views of the actuator 100 of the system 90 of FIG. 1 according to the first exemplary embodiment. The actuator 100 includes (amongst other things): (i) the ejector plate 130, and (ii) connecting links 132A, 132B. Other connecting links are hidden behind the connecting links 132A, 132B in this view. FIG. 8 depicts additional connecting links 132C, 132D. Referring to FIG. 2, the connecting links 132A, 132B are configured to: (i) move the ejector plate 130, and (ii) maintain orientation of the ejector plate 130 (as the ejector plate 130 is moved) substantially parallel relative to a mold-support face of the moveable platen 114. The mold-support face is used to mountably support the moveable mold portion (which is depicted in FIG. 5A). The connecting links 132A, 132B are coupled to (preferably, pivotally connected to) the ejector plate 130. The ejector plate 130 is configured to support a set of ejector rods. The ejector rods are depicted at least in part as item 160 in FIGS. 5A, 5B, 6A, 6B, 7A and 7B. FIG. 13 depicts twelve ejector rods 160 that are connected to the ejector plate 130. Referring to FIG. 3, the connecting links 132A, 132B are configured to transmit respective substantially balanced applied forces 139A, 139B (hereafter referred to as the “balanced forces”) to the ejector plate 130. FIG. 8 depicts balanced applied forces 139A, 139B, 139C, 139D each of which is associated with the connecting links 132A, 132B, 132C, 132D respectively. Referring to FIG. 3, the ejector plate 130 distributes the balanced applied forces 139A, 139B to the set of ejector rods via the ejector plate 130. The balanced applied forces 139A, 139B move the ejector plate 130 and the ejector rods along an orthogonal direction 300 relative to the ejector plate 130 while substantially reducing movement of the set of ejector rods along a non-orthogonal direction 302 relative to the ejector plate 130. Referring to FIG. 2, each of the connecting links 132A, 132B preferably include (respectively): (i) ends 137A, 137B and (ii) other ends 143A, 143B (hereafter referred to as the “ends 143A, 143B”), and (iii) stops 135A, 135B. The ends 143A, 143B are offset from the ends 137A, 137B respectively. The ends 143A, 143B are configured to pass, at least in part, through apertures 131A, 131B (respectively) that are defined by the ejector plate 130. The stops 135A, 135B extend from the connecting links 132A, 132B, respectively, so that the stops 135A, 135B are abuttable against the ejector plate 130, and in this manner the stops 135A, 135B limit rotational movement (preferably pivotal movement) of respective connecting links 132A, 132B relative to the ejector plate 130. The stops 135A, 135B (each may be called a “protrusion tooth”) are used to limit swing displacement of the connecting links 132A, 132B, and this manner the connecting links 132A, 132B are prevented from swinging past their respective center lines. In effect, the stops 135A, 135B provide a hard stop. If the stops 135A, 135B are not used and if the connecting links 132A, 132B are allowed to rotate over their respective center lines, movement of the ejector plate 130 may change direction while a molded article is ejected, and this condition may be undesirable in some circumstances. The stops 135A, 135B are not essential but they provide improved operation of the actuator 100. Preferably, the actuator 100 also includes, respectively for the connecting links 132A, 132B: (i) link shafts 136A, 136B, (ii) ejector plate shafts 140A, 140B, (iii) shaft bearings 144A, 144B, and (iv) crank bearings 138A, 138B. The link shafts 136A, 136B are rotatably mounted to the ends 137A, 137B (respectively). The ejector plate shafts 140A, 140B are rotatably mounted to the ends 143A, 143B respectively. The ejector plate shafts 140A, 140B are fixedly connected to the ejector plate 130. The shaft bearings 144A, 144B are received in the ends 143A, 143B respectively. The shaft bearings 144A, 144B permit rotational movement of the connecting links 132A, 132B respectively relative to the ejector plate shafts 140A, 140B. The crank bearings 138A, 138B are received in the ends 137A, 137B respectively. The crank bearings 138A, 138B permit rotational movement of the connecting links 132A, 132B respectively relative to the link shafts 136A, 136B. Referring to FIG. 3, the connecting links 132A, 132B impart the balanced applied forces 139A, 139B to the ejector plate 130. Transmission of the balanced applied forces 139A, 139B includes: (i) transmission of net orthogonal translational forces 133A, 133B to the ejector plate 130 so as to translate the ejector plate 130 toward the moveable platen 114, and (ii) transmission of net non-orthogonal forces 141A, 141B to the ejector plate 130 that are substantially reduced as the net orthogonal translational forces 133A, 133B are applied to the ejector plate 130. The net orthogonal translational forces 133A, 133B are aligned along an orthogonal direction 300 relative to the ejector plate 130. The net non-orthogonal forces 141A, 141B are aligned along a non-orthogonal direction 302 relative to the ejector plate 130. The net non-orthogonal forces 141A, 141B associated with the connecting links 132A, 132B (respectively) substantially cancel each other, preferably, to a net zero force that is directed along a direction that is aligned along the non-orthogonal direction 302 relative to the ejector plate 130. A technical effect, amongst others, of the foregoing arrangement is: (i) a reduction of wear associated with the components of the ejector plate 130, and/or (ii) equalizing releasing force associated with ejector rods. State-of-the-art actuators apply or direct a translation force directly toward the center of an ejector plate, and the translation force is distributed to the ejector rod(s) from the center of the ejector plates. In sharp contrast, the actuator 100 distributes the translation force (at least in part) over the ejector plate 130 to the set of ejector rods. The ejector plate 130 is moved, by the actuator 100, in a way that keeps or maintains the ejector plate 130 in a parallel orientation relative to the moveable mold portion of the mold. The ejector rod may be a single ejector rod, or more preferably, may be a set of ejector rods. Known industry standards dictate predetermined locations of the ejector rods, such as: (i) the SPI (Society of Plastics Industry), (ii) the European Committee of Machinery Manufacturers for the Plastics and Rubber Industries (Euromap), and (iii) Japan Plastics Industry (JIS). Preferably, the actuator 100 accommodates these standards so that the ejection rods are maintained in desired, standard positions. It is preferred to locate the connecting links 132A, 132B so as to accommodate connection of ejector rods to the ejector plate 130 at standard positions without having to relocate the connecting links 132A, 132B.

FIG. 4 is the side view of the actuator 100 of the system 90 of FIG. 1 according to the second exemplary embodiment. The actuator 100 further includes a set of cranks 146A, 146B each respectively having: (i) pivot ends 149A, 149B, (ii) link shaft ends 147A, 147B, (iii) crank shafts 148A, 148B, and (vi) snap rings 153A, 153B. The cranks 146A, 146B are pivotally connected to the connecting links 132A, 132B respectively. The crank shafts 148A, 148B are fixedly connected to respective cranks 146A, 146B. The crank shafts 148A, 148B are fixedly connected to the cranks 146A, 146B respectively; there are different ways to do implement the connection between the cranks 146A, 146B and the crank shafts 148A, 148B respectively, such as: welding, press fitting, shrink fitting, spline fitting, etc. A cost-effective way is to use a shrink fitting approach. The link shaft ends 147A, 147B are offset from the pivot ends 149A, 149B respectively. The link shaft ends 147A, 147B are fixedly mounted to the link shafts 136A, 136B respectively. The crank shafts 148A, 148B are fixedly mounted to the pivot ends 149A, 149B respectively. The crank shafts 148A, 148B are actuated so as to rotate the cranks 146A, 146B respectively. The cranks 146A, 146B are counter rotated relative to each other. The snap rings 153A, 153B are used to prevent side-to-side movement of the cranks 146A, 146B relative to the crank shafts 148A, 148B respectively. The connecting links 132A, 132B each defines notches 134A, 134B respectively. The notches 134A, 134B are used to accommodate the crank shafts 148A, 148B respectively so as to permit the connecting links 132A, 132B to rotate closer to the crank shafts 148A respectively. If the notches 134A, 134B are not used and when the cranks 146A, 146B are rotated, pivotal rotation of the connecting links 132A, 132B may interfere with the crank shafts 148A, 148B respectively. Usage of the notches 134A, 134B provides additional clearance so that rotation of the connecting links 132A, 132B does not interfere with the crank shafts 148A, 148B respectively. In effect, notching the connecting links 132A, 132B helps to extend the travel of the elector plate 130. According to variant (not depicted), notches are placed on the crank shafts 148A, 148B and the connecting links 132A, 132B are straight pieces that do not define notches. According to another variant (not depicted), corresponding notches are defined on: (i) the crank shafts 148A, 148B, and (ii) the connecting links 132A, 132B. If the connecting links 132A, 132B define no notches and the crank shafts 148A, 148B define no notches, travel of the cranks 146A, 146B may be limited and this condition may be undesirable in some implementations of the actuator 100. Notches are not considered to be essential, but rather the notches may improve operation of the actuator 100.

FIGS. 5A and 5B are the side views of the actuator 100 of the system 90 of FIG. 1 according to the third exemplary embodiment. For the sake of simplifying FIGS. 5A, 5B, a single ejector rod is depicted. An ejector rod 160 is fixedly connected to and extends from the ejector plate 130. The ejector rod 160 is moveable through a channel defined by the moveable platen 114 and another channel defined by a moveable mold portion 164 of the mold 115. The ejector rod 160 is abuttable against the molded article 176 that is retained in the moveable mold portion 164 of the mold 115. A guidance assembly 151 supportively guides linear movement of the ejector plate 130 relative to the moveable platen 114. The guidance assembly 151 includes: (i) guidance rods 150A, 150B, and (ii) retainers 168A, 168B. The guidance rods 150A, 150B are fixedly connected to the moveable platen 114, preferably by way of threaded connections. The guidance rods 150A, 150B are aligned along a direction that extends: (i) substantially orthogonal relative to the moveable platen 114, and (ii) along the axis of movement of the moveable platen 114. The guidance rods 150A, 150B are safety feature, in that they constrain the ejector plate 130 (that is, they prevent the ejector plate 130 from dropping due to gravity). The retainers 168A, 168B are fixedly connected to the free end of the guidance rods 150A, 150B respectively. The retainers 168A, 168B are abuttable against the ejector plate 130 so as to limit extended movement of the ejector plate 130. Responsive to pivotal rotation of the connecting links 132A, 132B, the ejector plate 130 is translated along the guidance rods 150A, 150B between a retracted position and an extended position. In the retracted position (as depicted in FIG. 5A), the ejector plate 130 has been moved away from the moveable platen 114 so that the ejector rod 160 becomes retracted from the mold cavity 174 that is defined by the moveable mold portion 164 of the mold 115. In the extended position (as depicted in FIG. 5B), the ejector plate 130 has been moved toward the moveable platen 114 so that the ejector rod 160 is made to protrude into, at least in part, the mold cavity 174, and the ejector rod 160 is used to urge the molded article 176 from the mold cavity 174 that is defined by the moveable mold portion 164. According to a variant (not depicted), the connecting links 132A, 132B are not located between the ejector plate 130 and the moveable platen 114, but the connecting links 132A, 132B are located on the same side of the ejector plate 130 that the retainers 168A, 168B are located. It is preferred to locate the connecting links 132A, 132B as depicted in FIGS. 5A and 5B to make the actuator 100 as compact as possible.

FIGS. 6A and 6B are the side views of the actuator 100 of the system 90 of FIG. 1 according to the fourth exemplary embodiment, in which the guidance assembly 151 includes springs 171A, 171B that are received between the retainers 168A, 168B respectively and the ejector plate 130. In the retracted position (as depicted in FIG. 6A), the ejector plate 130 has been moved away from the moveable platen 114 so that the springs 171A, 171B become compressed so as to store energy. In the extended position (as depicted in FIG. 6B), the ejector plate 130 has been moved toward the moveable platen 114 so that the springs 171A, 171B may become decompressed so as to release their stored energy, which was used to assist the connecting links 132A, 132B in linearly translating the ejector plate 130 toward the moveable platen 114. The springs 171A, 171B are used to provide additional ejection force to the ejector rod 160 once the connecting links 132A, 132B are rotated so as to translate the ejector plate 130.

FIGS. 7A and 7B are the side views of the actuator 100 of a system 90 of FIG. 1 according to the fifth exemplary embodiment. The actuator 100 includes a spring assembly 154. The spring assembly 154 includes: (i) a stationary frame 178, (ii) a rod 180, (iii) a cylinder 181, (iv) a piston 182, and (v) a piston spring 184. The combination of the rod 180, the cylinder 181, the piston 182 and the piston spring 184 is called a spring pack. The stationary frame 178 is offset from the ejector plate 130. The stationary frame 178 may be fixedly attached to the ends of the guidance rods 150A, 150B. The piston spring 184 is received in the cylinder 181. The piston 182 is received in the cylinder 181, and the piston 182 is abuttable against the piston spring 184. The rod 180 is connected to the piston 182, and the rod 180 is slidably moveable through a channel defined by the ejector plate 130. The cylinder 181 is mounted to the ejector plate 130. When the actuator 100 is in the retracted position (as depicted in FIG. 7A), the ejector plate 130 is moved away from the moveable platen 114, and the ejector plate 130 is moved toward the stationary frame 178 sufficiently enough so that the rod 180 is made to: (i) abut the stationary frame 178 and (ii) slidably move toward the moveable platen 114 sufficiently enough to so as to cause the piston spring 184 to become compressed and thereby store potential energy. The piston spring 184 may, when not compressed, remain in either (i) a free length, or (ii) a preloaded condition. When the ejector plate 130 is retracted (that is, moved away from the moveable platen 114), the piston spring 184 becomes compressed so as to store energy. The stored energy of the piston spring 184 provides additional force to move the ejector plate 130 toward the moveable platen 114 so that, in effect, a larger force may be used for ejecting the molded article 176. During retraction of the ejector plate 130, torque transmitted to the crank shafts 148A, 148B is used, in part, to compress the piston spring 184 so as to accumulate or store energy in the piston spring 184. When in the extended position (as depicted in FIG. 7B), the ejector plate 130 is moved toward the moveable platen 114, and the ejector plate 130 is moved away from the stationary frame 178 sufficiently enough so that the piston spring 184 may release its stored, potential energy, which is used to assist the connecting links 132A, 132B in the act of translating the ejector plate 130 toward the moveable platen 114, and in turn the ejector rod 160 is made to eject the molded article 176. When ejecting the molded article 176, the stored energy in the piston spring 184 is used along with the force obtained from the rotation of the crank shafts 148A, 148B. A smaller-sized electric motor (not depicted) may be used to rotate the crank shafts 148A, 148B if the piston spring 184 is used. In the case where the piston spring 184 is not used, the electric motor used to rotate the crank shafts 148A, 148B is sized accordingly larger to compensate for energy formerly provided by the piston spring 184.

FIG. 8 is the perspective view of the actuator 100 of the system 90 of FIG. 1 according to the first exemplary embodiment. The connecting links 132A, 132B, 132C, 132D are pivotally connected to respective corners of the ejector plate 130. The connecting links 132A, 132B, 132C, 132D are offset from one another such that the ejector plate 130 may remain substantially parallel to the moveable mold portion 164 as the ejector plate 130 is translated. The connecting links 132A, 132B, 132C, 132D are separated into: (i) a set of connecting links 132A, 132C, and (ii) another set of connecting links 132B, 132D. The set of connecting links 132A, 132C are configured to fold symmetrically relative to the set of connecting links 132B, 132D. According to a variant (not depicted), set of three connecting links are: (i) positioned offset from each other, and (ii) pivotally connected to a top side of the ejector plate 130, and an additional set of three connecting links are: (i) positioned offset from each other, and (ii) pivotally connected to a bottom side of the ejector plate 130. According to another variant (not depicted), a set of two connecting links are: (i) positioned offset from each other, and (ii) pivotally connected to the top side of the ejector plate 130, and a single connecting link is pivotally connected to the bottom side of the ejector plate 130 through a center line extending through the ejector plate 130.

FIGS. 9, 10 and 11 are the perspective views of the actuator 100 of the system 90 of FIG. 1 according to the third exemplary embodiment. The crank shaft 148A is fixedly connected (mounted) to a subset of cranks 146A, 146C. The crank shaft 148B is fixedly connected to a subset of cranks 146B, 146D. The crank shafts 148A, 148B are counter rotated respective to each other. The movement of the crank shafts 148A, 148B occurs substantially simultaneously so as to move the ejector plate 130 substantially parallel to the moveable mold portion 164. The actuator 100 includes a set of shaft supports 152A, 152C that are configured to support position of the crank shaft 148A (preferably, to maintain the crank shaft 148A in a fixed orientation). Another set of shaft supports 152B, 152D are configured to support position of the crank shaft 148B.

FIG. 12 is the perspective view of the actuator 100 of the system 90 of FIG. 1 according to the fifth exemplary embodiment. The actuator 100 includes the guidance rods 150A, 150B, 150C, 150D that are preferably located in a symmetrical orientation relative to each other. The guidance rods 150A, 150B, 150C, 150D are each positioned at a respective point located midway between the corners of the ejector plate 130 at the peripheral edges of the ejector plate 130. The ejector plate 130 defines four channels each of which accommodate movement of the ejector plate 130 relative to the guidance rods 150A, 150B, 150C, 150D. Four spring assemblies 154 are positioned and mounted, preferably, to the ejector plate 130 in a symmetrical orientation relative to each other. Additional channels are defined by the ejector plate 130 so as to accommodate movement of the rod 180 of each spring assembly 154.

FIG. 13 is the perspective view of the actuator 100 of the system 90 of FIG. 1 according to the sixth exemplary embodiment. Twelve ejector rods 160 are fixedly attached to, and extend from, the ejector plate 130.

FIG. 14 is the schematic representation of the actuator 100 of the system 90 of FIG. 1 according to the sixth exemplary embodiment. The actuator 100 includes a drive assembly 192 that has: (i) an electric motor 187 (that is preferably a servo motor), (i) a drive shaft 186, (iii) a belt 190, and (iv) a tensioner 188. The drive shaft 186 is connected to the motor 187 that is configured to rotate the drive shaft 186. The belt 190 connects the drive shaft 186 to the crank shafts 148A, 148B. The drive shaft 186 is configured to move (rotate) the belt 190. The tensioner 188 is configured to maintain tension on the belt 190. The drive assembly 192 is configured to rotate the crank shaft 148A in the opposite direction of the rotation of the crank shaft 148B. Counter rotating movement of the crank shafts 148A, 148B occurs substantially simultaneously so as to maintain the ejector plate 130 substantially parallel to the moveable mold portion 164 as the ejector plate 130 is linearly translated. The belt 190 is preferably a double-sided toothed belt. According to a variant, springs are not used to assist in moving the ejector rods 160, and a larger-sized electric motor is used to generate the required torque to move the ejector plate 130 so that the larger motor would compensate for the loss of stored spring energy formerly provided by the springs. In response to rotation of the drive shaft 186 by the electric motor, the belt 190 moves so as to rotate the crank shafts 148A, 148B. In response to rotation of the crank shafts 148A, 148B by the belt 190, the cranks 146A, 146B, 146C, 146D rotate so as to move (displace) the connecting links 132A, 132B, 132C, 132D respectively. In response to the connecting links 132A, 132B, 132C, 132D being moved (pushed) by the cranks 146A, 146B, 146C, 146D, the ejector plate 130 receives the balanced applied forces 139A, 139B, 139C, 139D from the connecting links 132A, 132B, 132C, 132D respectively. In response to the ejector plate 130 receiving the balanced applied forces 139A, 139B, 139C, 139D, the set of ejector rods 160 move through: (i) channels defined by the moveable platen 114, and (ii) channels defined by the moveable mold portion 164, so that the set of ejector rods 160 may push the molded article 176 from the moveable mold portion 164. It will be appreciated that each of the connecting links 132A, 132B, 132C, 132D are preferably, similarly shaped and function in the same manner.

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are the subject of dependent claims. Therefore, what is to be protected by way of letters patent are limited only by the scope of the following

What is claimed is:

1. An actuator of a molding system, the actuator comprising:
an ejector plate configured to support an ejector rod; and
connecting links coupled to the ejector plate, the connecting links are configured to transmit substantially balanced applied forces to the ejector plate.

2. The actuator of claim 1, wherein the connecting links are configured maintain the ejector plate substantially parallel relative to a mold-support face of a moveable platen as the ejector plate is moved relative to the moveable platen.

3. The actuator of claim 1, wherein the ejector plate distributes the substantially balanced applied forces to the ejector rod, the substantially balanced applied forces move the ejector rod along an orthogonal direction relative to the ejector plate while substantially reducing movement of the ejector rod along a non-orthogonal direction relative to the ejector plate.

4. The actuator of claim 1, wherein:
the substantially balanced applied forces includes a net orthogonal translational force and a net non-orthogonal force, and
the connecting links are configured to transmit to the ejector plate: (i) the net orthogonal translational force being sufficiently large enough to translate the ejector plate, and (ii) the net non-orthogonal force being substantially reduced as the net orthogonal translational force is transmitted to the ejector plate.

5. The actuator of claim 1, wherein transmission of the substantially balanced applied forces includes:
transmission of a net orthogonal translational force to the ejector plate so as to translate the ejector plate, the net orthogonal translational force being aligned orthogonal relative to the ejector plate, and
transmission of a net non-orthogonal force to the ejector plate that is substantially reduced as the net orthogonal translational force is transmitted to the ejector plate, the net non-orthogonal force being aligned non-orthogonal relative to the ejector plate.

6. The actuator of claim 1, wherein the ejector rod is moveable through a moveable platen and a moveable mold portion supported by the moveable platen, once transmission of substantially balanced applied forces is applied, the ejector rod pushes against a molded article to be molded and retained in the moveable mold portion.

7. The actuator of claim 1, wherein the connecting links are pivotally coupled to the ejector plate.

8. The actuator of claim 7, further comprising:
cranks each pivotally connected to a respective link of the connecting links.

9. The actuator of claim 8, further comprising:
crank shafts each fixedly connected to respective cranks.

10. The actuator of claim 9, further comprising:
a drive shaft; and
a belt coupling the drive shaft to the crank shafts.

11. The actuator of claim 9, further comprising:
a drive shaft;
an electric motor coupled to the drive shaft; and
a belt coupling the drive shaft to the crank shafts.

12. The actuator of claim 9, further comprising:
a drive shaft;
an electric motor coupled to the drive shaft; and
a belt coupling the drive shaft to the crank shafts,
in response to the drive shaft being rotated by the electric motor, the belt moves so as to rotate the crank shafts,
in response to the crank shafts being rotated by the belt, the cranks rotate so as to move the connecting links,
in response to the connecting links being pushed by the cranks, the ejector plate receives the substantially balanced applied forces from the connecting links, and
in response to the ejector plate receiving the substantially balanced applied forces, the ejector rod moves through a moveable platen of the molding system and a moveable mold portion supported by the moveable platen, the ejector rod pushes a molded article molded and retained in the moveable mold portion.

13. The actuator of claim 1, wherein:
the connecting links each include:
an end; and
another end offset from each end, the another end being configured to pass through an aperture defined by the ejector plate; and
the actuator further comprises:
a link shaft rotatably mounted to each end; and
an ejector plate shaft rotatably mounted to the another end, the ejector plate shaft fixedly connected to the ejector plate.

14. The actuator of claim 1, wherein the connecting links include a stop extending from each connecting link, the stop being abuttable against the ejector plate so as to limit rotational movement of each connecting link relative to the ejector plate.

15. The actuator of claim 1, wherein each connecting link defines a respective notch each configured to accommodate a respective crank shafts so as to permit the respective crank shafts to rotate closer to the connecting links.

16. The actuator of claim 1, further comprising:
a guidance assembly configured to supportive movement of the ejector plate.

17. The actuator of claim 1, further comprising:
a guidance assembly configured to supportive movement of the ejector plate, the guidance assembly includes:
a guidance rod connected and aligned substantially orthogonal to a moveable platen, the guidance rod configured to supportively guide movement of the ejector plate relative to a moveable platen.

18. The actuator of claim 1, further comprising:
a guidance assembly configured to supportive movement of the ejector plate, the guidance assembly includes:
a guidance rod connected and aligned substantially orthogonal to a moveable platen, the guidance rod configured to supportively guide movement of the ejector plate relative to the moveable platen; and
a retainer fixedly connected to the free end of the guidance rod, the retainer configured to be abuttable against the ejector plate so as to limit movement of the ejector plate away relative to the moveable platen, wherein movement of the connecting links translates the ejector plate along the guidance rod between a retracted position and an extended position.

19. The actuator of claim 1, wherein:
in a retracted position, the ejector rod is retracted from a mold cavity of a moveable mold portion, and
in the extended position, the ejector rod: (i) protrudes, at least in part, into the mold cavity, and (ii) urges the molded article from the mold cavity.

20. The actuator of claim 1, further comprising:
a guidance assembly configured to supportive movement of the ejector plate, the guidance assembly includes:
a guidance rod connected and aligned substantially orthogonal to a moveable platen, the guidance rod configured to supportively guide movement of the ejector plate relative to the moveable platen;
a retainer fixedly connected to the free end of the guidance rod, the retainer configured to be abuttable against the ejector plate so as to limit movement of the ejector plate away relative to the moveable platen; and
a spring received by a guidance rod between the retainer and ejector plate, in the retracted position of the ejector plate, the spring is compressed so as to store energy, and in the extended position of the ejector plate, the spring is decompressed so as to release stored energy to assist translation of the ejector plate toward a moveable platen.

21. The actuator of claim 1, further comprising:
a spring assembly including:
a cylinder mounted to the ejector plate;
a piston spring received in the cylinder;
a piston received in the cylinder, the piston configured to be abuttable against the piston spring;
a rod connected to the piston, the rod is slidably moveable through the ejector plate; and
a stationary frame offset from the ejector plate.

22. The actuator of claim 1, further comprising:
a spring assembly including:
a cylinder mounted to the ejector plate;
a piston spring received in the cylinder;
a piston received in the cylinder, the piston configured to be abuttable against the piston spring;
a rod connected to the piston, the rod is slidably moveable through the ejector plate; and
a stationary frame offset from the ejector plate,
in the retracted position, the ejector plate is moved toward a stationary frame sufficiently enough so that the rod is made to abut the stationary frame, the rod slidably moves toward the moveable platen sufficiently enough to compress the piston spring so as to store energy, and
in the extended position, the ejector plate is moved away from the stationary frame sufficiently enough to decompressed the piston spring so as to release stored energy to assist translation of the ejector plate toward the moveable platen.

23. The actuator of claim 1, wherein the connecting links includes:
a subset of connection links; and
another subset of connection links, the subset of connection links and the another subset of connection links are symmetrically foldable.

24. The actuator of claim 1, further comprising:
a crank shaft fixedly mounted to a set of link shaft ends of a subset of cranks, the crank shaft configured to rotate the subset of cranks clockwise; and
another crank shaft fixedly mounted to another set of link shaft ends of another subset of cranks, the another crank shaft configured to rotate the another subset of cranks counterclockwise.

25. The actuator of claim 1, further comprising:
a crank shaft fixedly mounted to a set of pivot ends of a subset of cranks, the crank shaft configured to rotate the subset of cranks clockwise; and
another crank shaft fixedly mounted to another set of pivot ends of another subset of cranks, the another crank shaft configured to rotate the another subset of cranks counterclockwise, movement of the crank shaft and the another crank shaft occurs substantially simultaneously to maintain the ejector plate substantially parallel to the moveable mold portion as the ejector plate is being translated.

26. The actuator of claim 1, further comprising:
a crank shaft fixedly mounted to a set of link shaft ends of a subset of cranks, the crank shaft configured to rotate the subset of cranks clockwise;
another crank shaft fixedly mounted to another set of link shaft ends of another subset of cranks, the another crank shaft configured to rotate the another subset of cranks counterclockwise; and
a drive assembly having:
a drive shaft connected to a motor configured to rotate the drive shaft;
a belt connecting the drive shaft to: (i) the crank shaft, and (ii) the another crank shaft, the drive shaft configured to move the belt; and
a tensioner configured to maintain tension one the belt, wherein movement of the crank shaft and the another crank shaft occurs substantially simultaneously to maintain the ejector plate substantially parallel to the moveable mold portion as the ejector plate is moved relative to the moveable mold portion.

27. An actuator of a molding system, the actuator comprising:
an ejector plate;
an ejector rod fixedly connected to the ejector plate;
connecting links pivotally coupled to the ejector plate, the connecting links, the connecting links configured to transmit substantially balanced applied forces to the ejector plate, the connecting links are configured maintain the ejector plate substantially parallel relative to a mold-support face of a moveable platen as the ejector plate is moved relative to the moveable platen;
cranks pivotally connected to a respective link of the connecting links;
crank shafts fixedly connected to respective cranks;
a drive shaft;
an electric motor configured to rotate the drive shaft; and
a belt coupling the drive shaft to the crank shafts,
in response to the drive shaft being rotated by the electric motor, the belt moves so as to rotate the crank shafts,
in response to the crank shafts being rotated by the belt, the cranks rotate so as to move the connecting links,
in response to the connecting links being pushed by the cranks, the ejector plate receives the substantially balanced applied forces from the connecting links,
in response to the ejector plate receiving the substantially balanced applied forces, the ejector rod moves through a moveable platen of the molding system and a moveable mold portion supported by the moveable platen, the ejector rod pushes a molded article molded and retained in the moveable mold portion, and
transmission of the substantially balanced applied forces includes: (i) transmission of a net orthogonal translational force to the ejector plate so as to translate the ejector plate, the net orthogonal translational force being aligned orthogonal relative to the ejector plate, and (ii) transmission of a net non-orthogonal force to the ejector plate that is substantially reduced as the net orthogonal translational force is transmitted to the ejector plate, the net non-orthogonal force being aligned non-orthogonal relative to the ejector plate.

28. A molding system, comprising:
an actuator including:
an ejector plate configured to support an ejector rod; and
connecting links coupled to the ejector plate, the connecting links are configured to transmit substantially balanced applied forces to the ejector plate.

29. The molding system of claim 28, wherein the connecting links are configured maintain the ejector plate substantially parallel relative to a mold-support face of a moveable platen as the ejector plate is moved relative to the moveable platen.

30. The molding system of claim 28, wherein the ejector plate distributes the substantially balanced applied forces to the ejector rod, the substantially balanced applied forces move the ejector rod along an orthogonal direction relative to the ejector plate while substantially reducing movement of the ejector rod along a non-orthogonal direction relative to the ejector plate.

31. A molding system, comprising:
a stationary platen configured to support a stationary mold portion of a mold;
a moveable platen being moveable relative to the stationary platen, the moveable platen configured to support a moveable mold portion of the mold;
an extruder configured to process and to inject a molding material into a mold cavity defined by the mold; and
an actuator including:
an ejector plate being moveable relative to the moveable platen;
an ejector rod fixedly connected to the ejector plate, the ejector rod being moveable through the moveable platen and the moveable mold portion so as to abut a molded article to be molded and retained in the moveable mold portion;
a guidance assembly configured to supportively guide movement of the ejector plate; and
connecting links pivotally coupled to the ejector plate, the connecting links are configured to transmit substantially balanced applied forces to the ejector plate, the connecting links are configured maintain the ejector plate substantially parallel relative to a mold-support face of a moveable platen as the ejector plate is moved relative to the moveable platen;
cranks pivotally connected to a respective link of the connecting links;
crank shafts fixedly connected to respective cranks;
a drive shaft;
an electric motor configured to rotate the drive shaft; and
a belt coupling the drive shaft to the crank shafts,
in response to the drive shaft being rotated by the electric motor, the belt moves so as to rotate the crank shafts,
in response to the crank shafts being rotated by the belt, the cranks rotate so as to move the connecting links,
in response to the connecting links being pushed by the cranks, the ejector plate receives the substantially balanced applied forces from the connecting links,
in response to the ejector plate receiving the substantially balanced applied forces, the ejector rod moves through a moveable platen of the molding system and a moveable mold portion supported by the moveable platen, the ejector rod pushes a molded article molded and retained in the moveable mold portion, and
transmission of the substantially balanced applied forces includes: (i) transmission of a net orthogonal translational force to the ejector plate so as to translate the ejector plate, the net orthogonal translational force being aligned orthogonal relative to the ejector plate, and (ii) transmission of a net non-orthogonal force to the ejector plate that is substantially reduced as the net orthogonal translational force is transmitted to the ejector plate, the net non-orthogonal force being aligned non-orthogonal relative to the ejector plate.

32. A molded article made by usage of an actuator of a molding system, the actuator comprising:
an ejector plate configured to support an ejector rod; and
connecting links coupled to the ejector plate, the connecting links are configured to transmit substantially balanced applied forces to the ejector plate.

33. The molded article of claim 32, wherein the connecting links are configured maintain the ejector plate substantially parallel relative to a mold-support face of a moveable platen as the ejector plate is moved relative to the moveable platen.

34. A molded article made by usage of a molding system, comprising:
an actuator including:
an ejector plate configured to support an ejector rod; and
connecting links coupled to the ejector plate, the connecting links are configured to transmit substantially balanced applied forces to the ejector plate.

35. The molded article of claim 34, wherein the connecting links are configured maintain the ejector plate substantially parallel relative to a mold-support face of a moveable platen as the ejector plate is moved relative to the moveable platen.

36. A method of an actuator of a molding system, comprising:
transmitting substantially balanced applied forces to an ejector plate, the ejector plate configured to support an ejector rod.

37. The method of claim 36, further comprising:
maintaining the ejector plate substantially parallel relative to a mold-support face of a moveable platen as the ejector plate is moved relative to the moveable platen.

38. The method of claim 36, further comprising:
moving the ejector rod along an orthogonal direction relative to the ejector plate while substantially reducing movement of the ejector rod along a non-orthogonal direction relative to the ejector plate.

39. The method of claim 36, further comprising:
distributing the substantially balanced applied forces to the ejector rod, the substantially balanced applied forces move the ejector rod along an orthogonal direction relative to the ejector plate while substantially reducing movement of the ejector rod along a non-orthogonal direction relative to the ejector plate.

40. The method of claim 36, further comprising:
transmitting to the ejector plate via connecting links:
a net orthogonal translational force being sufficiently large enough to translate the ejector plate, and
a net non-orthogonal force being substantially reduced as the net orthogonal translational force is transmitted to the ejector plate, the substantially balanced applied forces includes: (i) an orthogonal translational force, and (ii) a net non-orthogonal force.
